(19) United States
(12) Patent Application Publication
(10) Pub. No.: US 2010/0085670 A1
(43) Pub. Date: Apr. 8, 2010

(54) PHOTOVOLTAIC MODULE MONITORING SYSTEM

(76) Inventors: Krishnan Palaniswami, Portland, OR (US); David Drummond, Portland, OR (US); David C. Woody, JR., Tigard, OR (US); Timothy Dunn, Beaverton, OR (US)

Correspondence Address: Schwabe Williamson & Wyatt;PACWEST CENTER, SUITE 1900, 1211 SW FIFTH AVENUE, PORTLAND, OR, 97204, US

(21) Appl. No.: 12/575,293

(22) Filed: Oct. 7, 2009

Related U.S. Application Data
(60) Provisional application No. 61/103,366, filed on Oct. 7, 2008.

(51) Int. Cl. H02H 3/00; H02B 1/24; H02J 1/00

(52) U.S. Cl. 361/42; 307/112; 307/84; 361/87

(57) ABSTRACT

Embodiments of apparatuses, systems, articles, and methods related to a photovoltaic module monitoring system are disclosed. Other embodiments may be described and claimed.

### CROSS-REFERENCES TO RELATED APPLICATIONS

The present application claims priority to U.S. Provisional Application No. 61/103,366 filed on Oct. 7, 2008, which is hereby incorporated by reference in its entirety for all purposes except for those sections, if any, that are inconsistent with the present application.

### BACKGROUND

Recent years have seen a significant increase in both the number and scale of photovoltaic (PV) installations. Installing and maintaining PV modules of a PV installation may be associated with a number of challenges at both residential and commercial scales. Some typical challenges that may be encountered during a commissioning of a PV installation include incorrect and/or faulty wiring resulting in, e.g., incorrect polarity, open wiring, ground faults, loss of panel ground wire integrity, etc. Some typical challenges that may be encountered during operation of a PV installation include open wiring, resistive wiring, and ground faults. Occurrence of any of these situations could be detrimental to the electrical generation capacities of the PV installation.

### BRIEF DESCRIPTION OF THE DRAWINGS

Embodiments are illustrated by way of example and not by way of limitation in the figures of the accompanying drawings, in which like references indicate similar elements and in which:

FIG. 1 is a block diagram of a photovoltaic installation;

FIG. 2 is a block diagram of a managed module;

FIG. 3 is a block diagram of portions of a managed module;

FIG. 4 is a block diagram of a string combiner;

FIG. 5 is a block diagram of a string management unit;

FIG. 6 is a flow diagram of operations within a mapping procedure;

FIG. 7 is a flow diagram of operations within a procedure for detecting a ground fault;

FIG. 8 is a flow diagram of operations within another procedure for detecting a ground fault;

FIG. 9 is a flow diagram of operations within another procedure for detecting a ground fault;

FIG. 10 is a flow diagram of operations within a procedure for determining a location of a ground fault;

FIG. 11 is a flow diagram of operations within a procedure for detecting an open wire; and

FIG. 12 is a flow diagram of operations within a procedure for detecting a weak wire, all in accordance with some embodiments of the disclosure.

### DETAILED DESCRIPTION

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific devices and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the present disclosure; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise.

In providing some clarifying context to language that may be used in connection with various embodiments, the phrases “A/B” and “A and/or B” mean (A), (B), or (A and B); and the phrase “A, B, and/or C” means (A), (B), (C), (A and B), (A and C), (B and C) or (A, B and C).

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled to each other. The term “electrically coupled” means that two or more elements are in electrical communication with one another. The term “communicatively coupled” means that two or more elements are capable of communicating with one another. This communication may be done through a wired connection, a wireless connection, a network, etc.

Embodiments of this disclosure provide for systems, apparatuses, and methods to allow rapid and accurate detection of abnormalities that may exist in a photovoltaic (PV) installation. These abnormalities may result from installation errors and/or events that occur during operation of the PV installation. Embodiments also provide for continuous performance monitoring of PV modules in a PV installation during operation.

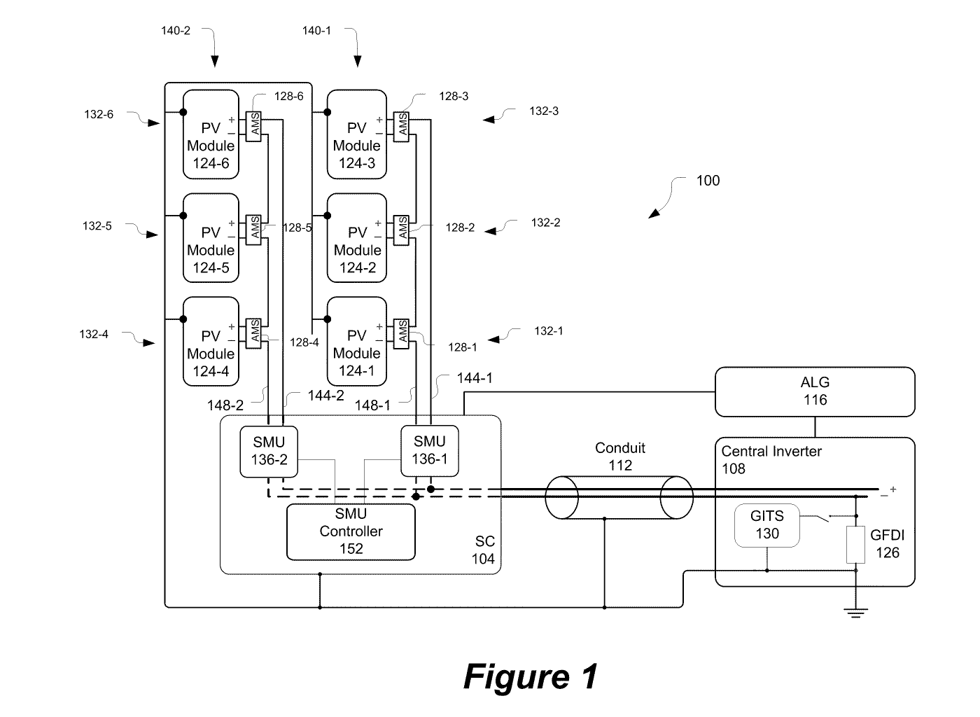

FIG. 1 is a block diagram of a PV installation 100 in accordance with some embodiments. The PV installation 100 may have a string combiner (SC) 104 electrically coupled with a central inverter 108 through a conduit 112; communicatively coupled with an array link gateway (ALG) 116; and electrically coupled with a number of PV modules 124, e.g., PV modules 124-1-124-6. The ALG 116 may operate to communicatively couple the PV installation 100 to a central management/monitoring facility over a network. The central inverter 108 may include a ground fault detection interrupt (GFDI) 126, to disconnect the PV installation when a ground fault is detected at the central inverter 108, and a ground integrity test source (GITS) 130, to test the integrity of a ground.

The PV installation 100 may also include a number of active module sensors (AMSs) 128, e.g., AMSs 128-1-128-6, with each of the AMSs 128 electrically coupled with a corresponding PV module 124 as generally shown in FIG. 1. In some embodiments, the AMS 128 may be a component that is external to its corresponding PV module 124, as is generally shown in FIG. 1. In other embodiments, the AMS 128, or components thereof, may be integrated into its corresponding PV module 124. A PV module 124 and its corresponding AMS 128 may be collectively referred to as a managed module 132.

As used herein, PV module 124 and PV modules 124 may respectively refer to a generic PV module and to more than one PV modules (up to all of the PV modules) depending on the context in which it is used. Also, use of a common portion of a reference number may indicate similar types of components; however, it does not imply that the components must be identical with one another. For example, PV module 124-1 may, or may not, be identical with PV module 124-2. These interpretations may also apply to other references used in a similar manner.

In addition to being electrically coupled with a PV module 124, the AMSs 128 may also be communicatively coupled with the SC 104. This may enable the AMSs 128 to communicate with the SC 104 to manage the PV modules 124 as will be described.

The SC 104 may include a string management unit (SMU) 136 coupled with each string 140 of PV modules 124. An SMU 136-1 may be coupled with a string 140-1 that includes managed modules 132-1-132-3; and an SMU 136-2 may be coupled with a string 140-2 that includes managed modules 132-4-132-6. In particular, the SMU 136-1 may be coupled with a positive string interconnect 144-1 and a negative string interconnect 148-1; and SMU 136-2 may be coupled with a positive string interconnect 144-2 and a negative string interconnect 148-2. The SC 104 may also include an SMU controller 152.

In some embodiments, such as the one shown in FIG. 1, there will be one AMS 128 per PV module 124; one SMU 136 per string 140; one SMU controller 152 per SC 104; and/or one ALG 116 per central inverter 108.

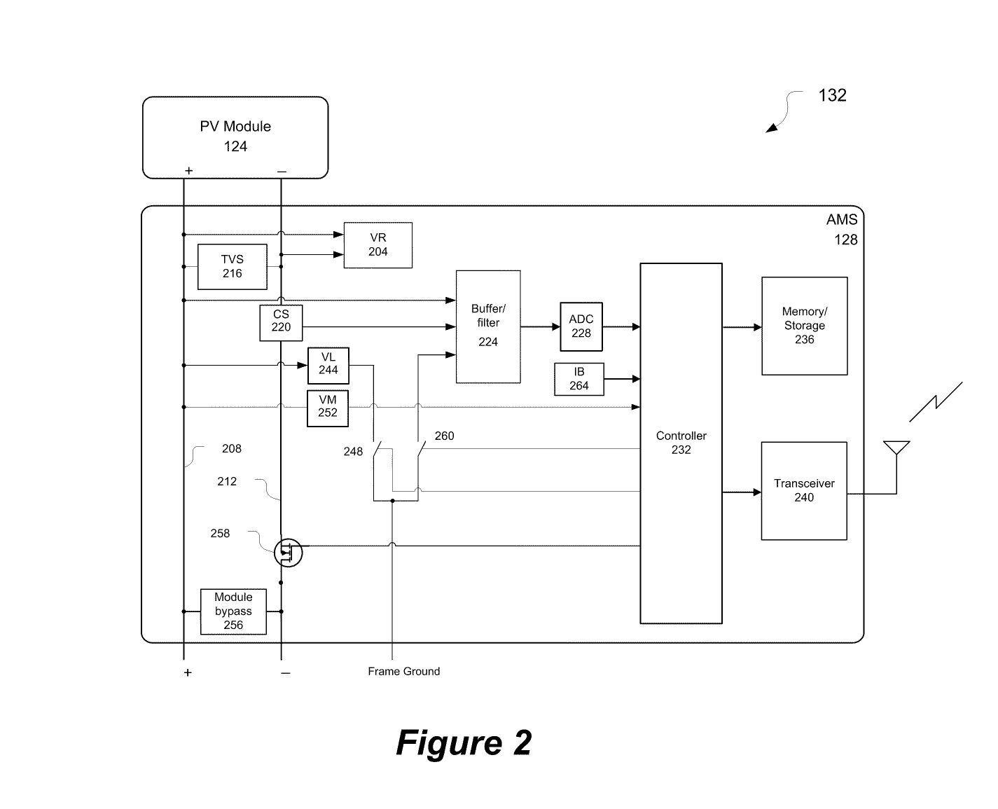

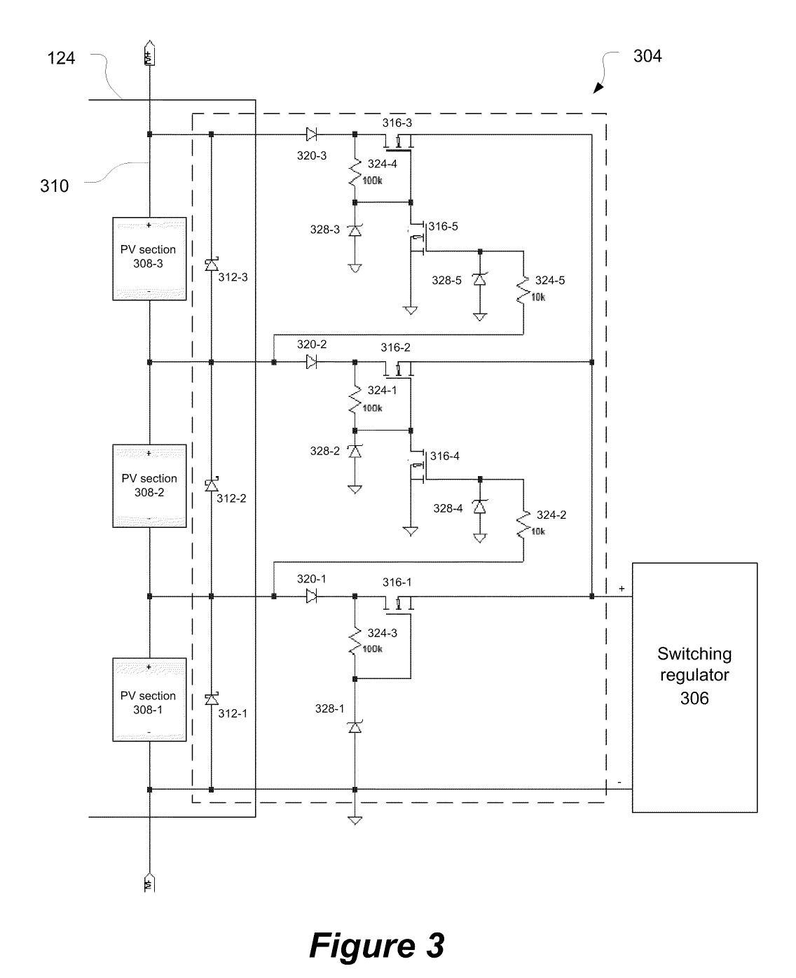

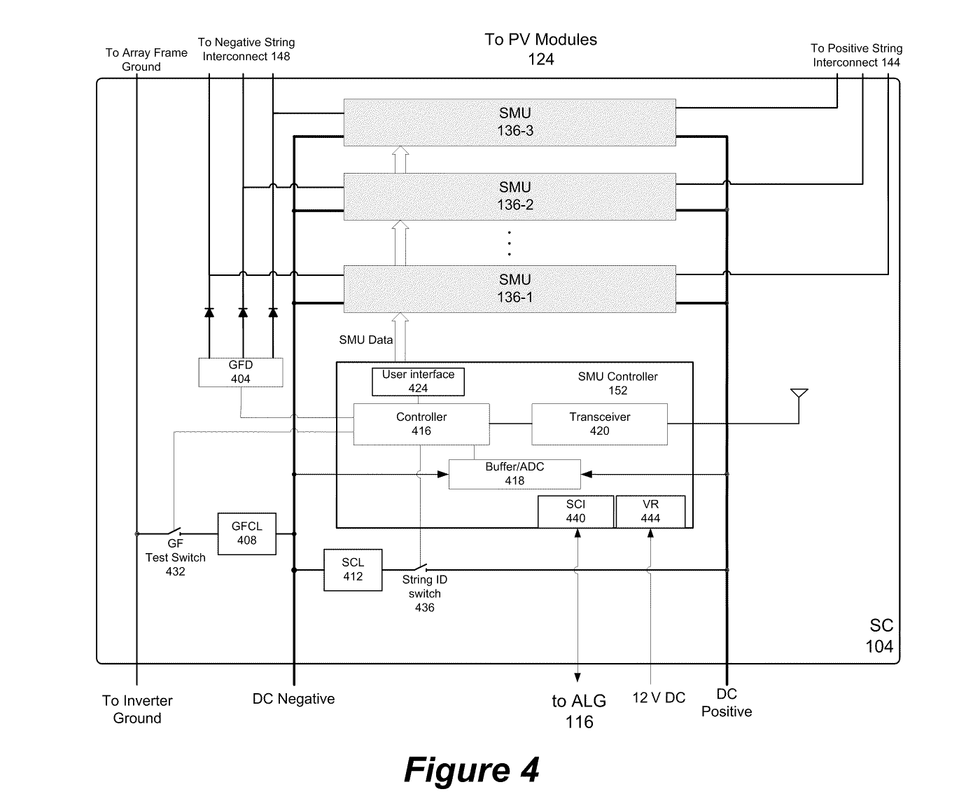

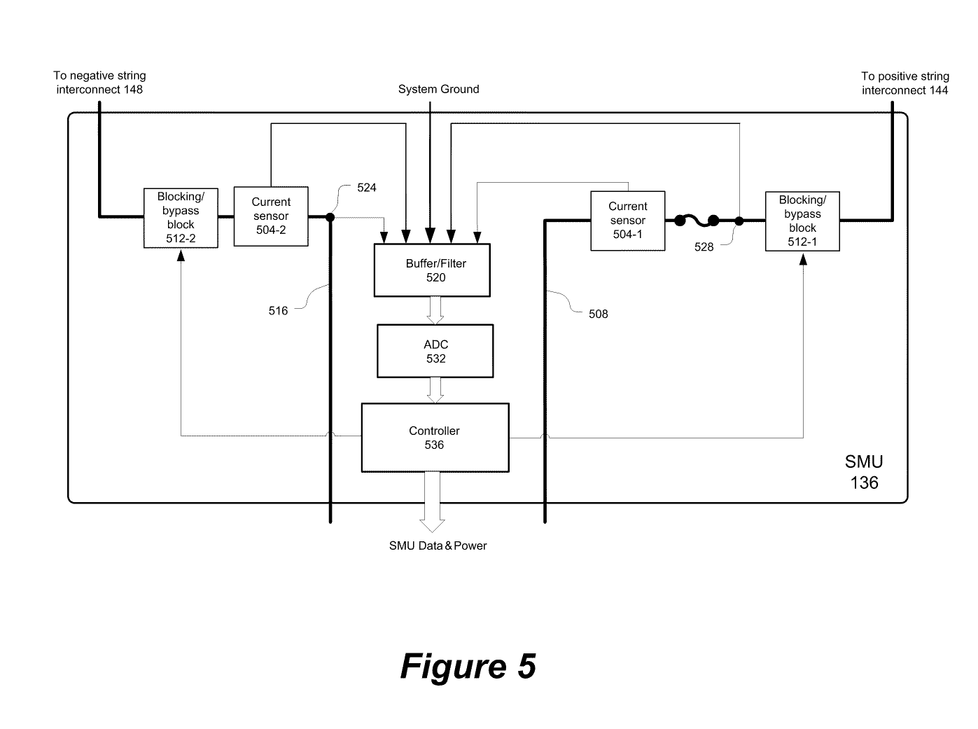

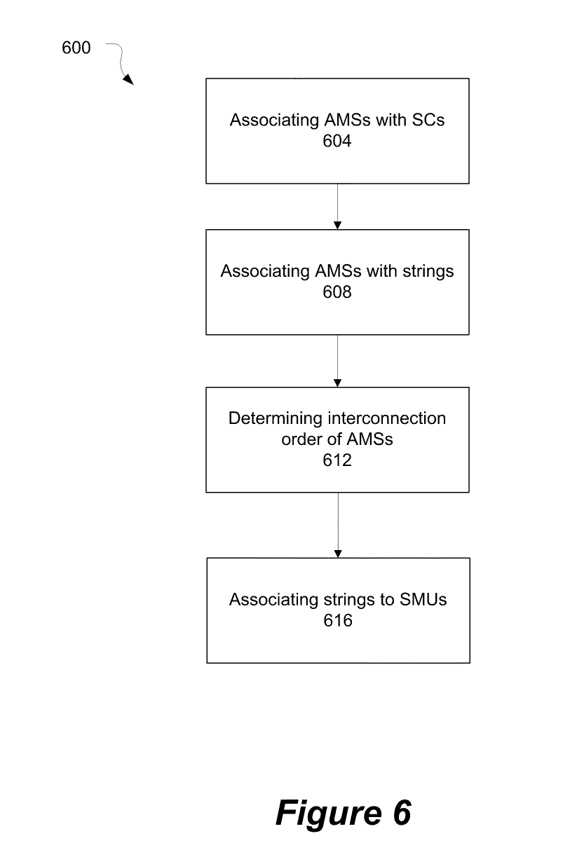

FIGS. 2-5 briefly introduce components of the managed module 132 (FIG. 2), the PV module 124 and a linear pre-regulator (FIG. 3), the SC 104 (FIG. 4), and the SMU 136 (FIG. 5) in accordance with some embodiments. These components may be discussed in further detail with respect to the procedures described in detail in FIGS. 6-12 in accordance with some embodiments.

FIG. 2 is a block diagram of a managed module 132 with additional details of an AMS 128 in accordance with some embodiments. The AMS 128 may include a voltage regulator (VR) 204 coupled with a positive interconnect 208 and a negative interconnect 212. As used herein, “interconnect” or “line” may include any type of conductor that may be used to electrically couple two components. This may include, but is not limited to, a wire, a trace, a conductive plane, etc.

The VR 204 may generate a controlled (e.g., substantially constant) voltage having characteristics desired for operation of other components of the AMS 128. The VR 204 may be a hybrid regulator with a linear pre-regulator followed by a switching regulator. The linear pre-regulator may step down the voltage of the positive interconnect 208 and the negative interconnect 212 to a voltage that is acceptable to the switching regulator.

FIG. 3 is a block diagram of portions of the managed module 132 including a linear pre-regulator 304 in accordance with some embodiments. The linear pre-regulator 304 may be placed between PV sections 308 and a switching regulator 306. The linear pre-regulator 304 may have three bypass diodes 312 respectively coupled, in parallel, with three PV sections 308 on section line 310 as shown. PV section 308-1 may be electrically coupled with M−, a negative terminal of the PV module 124, and PV section 308-3 may be electrically coupled with M+, a positive terminal of the PV module 124. In addition to being electrically coupled with M+ and M−, the linear pre-regulator 304 may be electrically coupled with the section line 310 at points between adjacent PV sections 308.

The linear pre-regulator 304 may also have a number of transistors, e.g., transistors 316-1-316-5, which may be NMOS transistors; a number of diodes, e.g., diodes 320-1-320-3; a number of resistors, e.g., resistors 324-1-324-5; and a number of additional diodes, e.g., Zener diodes 328-1-328-4, coupled to one another as shown. While the resistors 324 are shown with respective sizes of a particular embodiment, they may be other sizes in other embodiments.

In normal operation, transistors 316-2 and 316-3 may be turned off due to transistors 316-4 and 316-5 being turned on. When PV section 308-1 is bypassed due to, e.g., shading or a fault in bypass diode 312-1, transistor 316-2 may turn on to supply power to the switching regulator 306. Transistor 316-3 may be turned on when both bypass diodes 312-2 and 312-3 are bypassed due to e.g., shading or fault in bypass diodes 312-2 and/or 312-3.

Tapping the linear pre-regulator 304 into the section line 310 between adjacent PV sections 308, as shown, allows the use of smaller and lower cost components in the linear pre-regulator 304. This configuration may be desired in embodiments in which at least portions of the AMS 128 are incorporated into the PV module 124, as direct access to the section line 310 at points between adjacent PV sections 308 may not be available in embodiments in which the AMS 128 is externally coupled to a PV module 124 as may occur in, e.g., a retrofit deployment. The benefits of this configuration may be realized when the PV modules 124 are crystalline or high-voltage thin-film modules.

Referring again to FIG. 2, the AMS 128 may also include a transient voltage suppressor (TVS) 216 coupled with the positive interconnect 208 and the negative interconnect 212. The TVS 216 may protect electronics of the AMS 128 from transient overvoltage conditions that may result from nearby lightning strikes and other electrical disturbances. The TVS 216 may include, but is not limited to, a diode or a metal oxide varistor.

The AMS 128 may also include a current sensor (CS) 220 configured to measure current associated with the PV module 124. The current sensor 220 may be coupled with the negative interconnect 212 to facilitate implementation, e.g., by using smaller components. The current sensor 220 and the positive interconnect 208 may be coupled with a buffer/filter 224 that is configured to remove voltage transients and noise from voltage and current measurement prior to sampling by analog-to-digital circuit (ADC) 228. The ADC 228 may be coupled with a controller 232. The controller 232 may be coupled with memory/storage 236 and a wireless transceiver 240. The wireless transceiver 240 may be configured to communicatively couple the AMS 128 with the SC 104 via an over-the-air link. The wireless transceiver 240 may send various measurements (e.g., current and/or voltage measurements) to the SC 104 and/or receive various command messages from the SC 104. In some embodiments, the wireless transceiver 240 may be configured to operate in an Industrial, Scientific, and Medical (ISM) radio band; however, other embodiments are not so limited.

A “controller,” as used here and elsewhere, may be a processing component capable of controlling components coupled thereto in a manner to provide the described result. In some embodiments, the controller may be a microcontroller, a microprocessor, a system-on-a-chip, etc.

The AMS 128 may also include a voltage limiter (VL) 244 coupled with the positive interconnect 208 and a ground wire integrity check (GWIC) relay 248, which is controlled by the controller 232. The voltage limiter 244 may be configured to limit the voltage of PV module 124 to within limits established by the Underwriters Laboratories (UL) during a GWIC procedure.

The AMS 128 may also include a voltage monitor (VM) 252 coupled with the positive interconnect 208 and the controller 232. The voltage monitor 252 may be used to continuously monitor a voltage associated with the PV module 124 and provide an indication of the monitored voltage to the controller 232. The controller 232 and/or SC 104 may use the indication of the monitored voltage to detect a total module bypass condition or full module voltage drop due to ground faults as will be discussed in further detail below.

The AMS 128 may also include a module bypass 256 coupled to the positive interconnect 208 and the negative interconnect 212. The module bypass 256 may be a bypass diode that is used to bypass the PV module 124 when an N-switch 258 is opened (or has failed). The N-switch 258 may be an N-type metal-oxide semiconductor (MOS) switch, controlled by the controller 232, to cause the PV module to be selectively bypassed as is discussed in the procedures below.

The AMS 128 may also include a ground relay switch 260, controlled by the controller, and electrically coupled with the buffer/filter 224 and a frame ground. The ground relay switch 260 may be closed to isolate the AMS 128 from high voltages during installation or in an emergency event.

The AMS 128 may also include an identifier block (IB) 264 coupled with the controller 232. The identifier block 264 may store one or more identifiers that may be used to uniquely identify the AMS 128 and/or the PV module 124. These identifiers may be used to prevent the use of stolen and/or unauthorized components within the PV installation 100. In some embodiments, the identifier block 264 may store one or more serial numbers.

FIG. 4 is a block diagram of the SC 104 in accordance with some embodiments. The SC 104 may include, in addition to the components previously introduced in FIG. 1, a ground fault detector (GFD) 404; a ground fault current limiter (GFCL) 408; and a string current limiter (SCL) 412 in accordance with some embodiments.

The SMU controller 152 may include a controller 416 coupled with a buffer/ADC 418 and transceiver 420. The controller 416 may cooperatively interact with the transceiver 420 to receive status information (e.g., current and/or voltage measurements) from, and transmit control information (e.g., command messages) to, the AMSs 128. The controller 416 may also be coupled to a user interface 424 that may include a display, to provide an indication of status information, and/or a user input device, to receive controls and/or configuration information from a user.

The controller 416 may also be coupled to the GFD 404, a GF test switch 432, and a string ID switch 436 to facilitate mapping and ground fault detection, isolation and location procedures discussed below.

The SMU controller 152 may also include a serial communication interface (SCI) 440 configured to communicatively couple the SC 104 to the ALG 116.

The SMU controller 152 may also include a VR 444 configured to condition the voltage provided to the electronic components of the SMU controller 152.

FIG. 5 is a block diagram of an SMU 136 in accordance with some embodiments. The SMU 136 may include a current sensor 504-1 on a positive SMU line 508, which may be electrically coupled with the positive string interconnect 144 through a blocking/bypass block 512-1. A bypass portion of the blocking/bypass block 512-1 may reduce power dissipation in a blocking diode of the blocking/bypass block 512-1 during normal operation.

The SMU 136 may also include a current sensor 504-2 on a negative SMU line 516, which is electrically coupled to the negative string interconnect 148 through blocking/bypass block 512-2.

The SMU 136 may also include a buffer/filter 520 that is electrically coupled to the current sensors 504, a point 524, a point 528, and a system ground. The buffer/filter 520 may remove voltage transients and noise from voltage/current measurements prior to sampling by ADC 532. The sampled measurements may be provided from the ADC 532 to a controller 536, which may in turn, be provided to the SMU controller 152. The controller 536 may also be coupled with the blocking/bypass blocks 512.

The PV installation 100 may provide a number of capabilities beneficial to both an installer and an operator of the PV installation 100. In some embodiments, the PV installation 100 may provide mapping capabilities in which a complete map of the topology of the PV installation 100 may be discovered. This may facilitate rapid identification of installation errors and abnormalities that may occur in the PV installation 100 during operation. In some embodiments, the PV installation 100 may provide power monitoring capabilities. For example, during normal operation the power output of each individual PV module 124 may be available over a network through the ALG 116. This may allow rapid identification of failing modules, data logging to facilitate measuring long term power degradation, etc.

In some embodiments, the PV installation 100 may provide string monitoring capabilities. For example, during normal operation any damage or degradation of the wiring between PV modules 124 may be detected and its location determined.

In some embodiments, the PV installation 100 may provide theft detection capabilities. For example, the disappearance of one or more PV modules 124 from the PV installation 100 may be instantly detected and reported over the network through the ALG 116. This capability may also be provided at night when the PV modules 124 themselves are not producing power.

At least some of these and other capabilities will be described with respect to the procedures discussed below. Variables discussed within these descriptions may be provided in Table 1.

TABLE 1

| Name | Definition | Description |
|---|---|---|
| S_Vp(N) | M+ - M− | M+ voltage of the N^{th} PV module in a |
| | | string (PV module (N)) |
| S_VstrP(N) | FGND - M− | Non-inverted M− voltage of PV module (N) |
| S_VstrM(N) | M− - FGND | Inverted M− voltage of PV module (N) |
| S_Ip(N) | | Current through PV module (N) |
| P_Vstr | | Full string voltage |
| P_IstrP | | Full string current at positive string |
| | | interconnect |
| P_IstrM | | Full string current at negative string |
| | | interconnect |
| P_Vgnd | | Voltage developed between system |
| | | ground and negative string |
| | | interconnect |

Where FGND is the frame ground.

FIG. 6 is a flow diagram 600 of operations within a mapping procedure in accordance with some embodiments of the disclosure.

At block 604 (“Associating AMSs with SCs”), the mapping procedure may include the SC 104 identifying and associating with the AMSs 128 that are electrically coupled to the SC 104. The SC 104 may establish and maintain a radio hub with the AMSs 128 to allow wireless communication between the SC 104 and the AMSs 128. Each radio hub may have a unique hub identifier (ID) and be isolated from other radio hubs even if they are in the same radio space. In some embodiments, the SMU controller 152 may transmit a broadcast association message that includes the hub ID. AMSs 128 that are coupled to the SC 104 and, therefore, part of its radio hub, may receive the broadcast association message and adopt the hub ID of the broadcast message. AMSs that are not coupled to the SC 104 and, therefore, not part of its radio hub, may be turned off during the time the broadcast association message is sent from the SC 104 in order to prevent their adoption of the hub ID of the SC 104. If an AMS that is not coupled to the SC 104 has already adopted a hub ID of its associated SC, it may be left on and simply ignore the broadcast association message from the SC 104.

In some embodiments, if a hub ID associated with an AMS 128 is to be changed, e.g., due to incorrect initial association, the AMS 128 being moved to a different hub, etc., the AMS 128 may first receive a special message from SC 104 instructing it to discard its hub ID. Afterward, it may re-associate with another radio hub.

As used herein, instructions to the AMSs 128 (and other components) from the SC 104 (or other components) may be in the form of command messages sent over appropriate coupling paths.

At block 608 (“Associating AMSs with strings”), the mapping procedure may include the SC 104 associating each PV module 124 with its respective string 140. This may be done by the SMU controller 152 transmitting a series of command messages to the AMSs 128 to operate their respective N-switches 258 to selectively connect or disconnect corresponding PV modules 124 to the string 140. In some embodiments, the SMU controller 152 may instruct all of the AMSs 128 to control their N-switches 258 to disconnect their corresponding PV modules 124 from the strings 140. A particular AMS, e.g., AMS 128-1, may then be selected at random and instructed, by the SMU controller 152, to control its N-switch 258 to connect its PV module 124-1 to the string 140-1. The SMU controller 152 may then instruct another AMS 128 to control its N-switch 258 to connect its PV module 124 to an undetermined string 140. If the undetermined string 140 is string 140-1, the SC 104 may sense a non-zero voltage change, e.g., an increase, in the full string voltage, and the SMU controller 152 may determine that the tested PV module 124 is also on string 140-1. In this manner, the SMU controller 152 may work through each of the remaining AMSs 128 to determine which are associated with string 140-1. After all of the AMSs 128 of string 140-1 are identified, the SMU controller 152 may instruct all but one of the AMSs 128 not associated with string 140-1 to control their N-switches 258 to disconnect their corresponding PV modules 124 from the strings 140 and the process may be repeated. If there is any AMS 128 that is not accounted for after the SMU controller 152 works through all of the strings 140 coupled with the SC 104, then there may be a faulty connection.

At block 612 (“Determining interconnection order of AMS”), the mapping procedure may include the SC 104 determining the interconnection order of the AMSs 128 in the strings 140. This may be determined by grading values of voltages across M− terminals and the frame ground, i.e., S_VstrM values. In particular, the PV modules 124 closer to the SC 104 may have larger S_VstrM values. The S_VstrM values may be determined by the various AMSs 128 and reported to the SMU controller 152.

At block 616 (“Associating strings to SMUs”), the mapping procedure may include the SC 104 associating each of the strings 140 with a respective SMU 136 in the SC 104. The SMU controller 152 may instruct, e.g., AMS 128-1 in string 140-1 to control its N-switch 258 to connect PV module 124-1 to string 140-1. The SMU controller 152 may then turn on the string identification (ID) switch 436. The SMU controller 152 may then identify which SMU 136 has a current sensor 504 that records a current, e.g., SMU 136-1. SMU 136-1 may then be associated with the string under test, e.g., string 140-1. The SMU controller 152 may then instruct AMS 128-1 to control its N-switch 258 to disconnect PV module 124-1 from the string 140-1 and the process may be repeated with respect to the remaining strings 140 until all of the strings 140 are associated with a corresponding SMU 136.

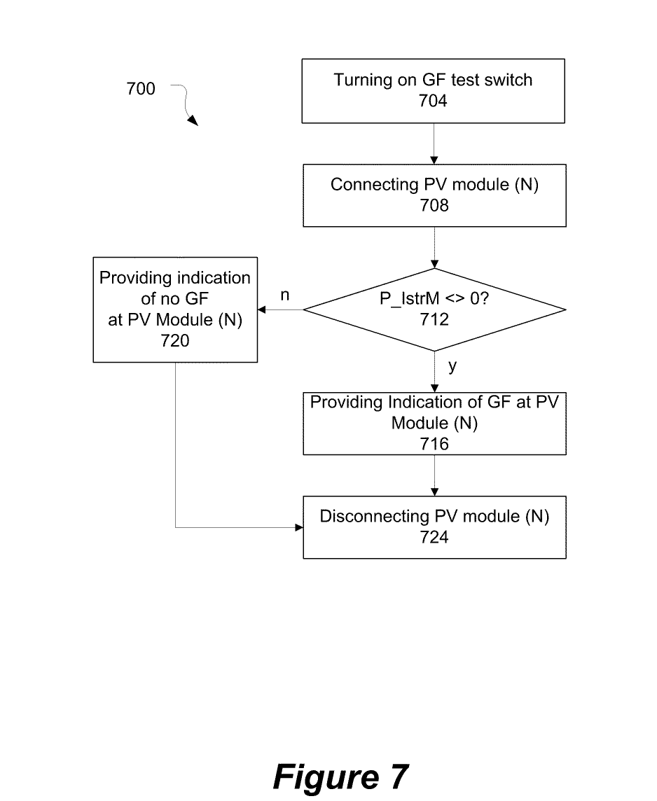

FIG. 7 is a flow diagram 700 of operations within a ground fault (GF) detection procedure in accordance with some embodiments of the disclosure. In particular, the flow diagram 700 may refer to detection of a low-resistance GF at the time of installation.

At block 704 (“Turning on GF test switch”), the SMU controller 152 may turn on the GF test switch 432, which should result in the string current of the negative string interconnect 148 going to zero.

At block 708 (“Connecting PV module (N)”), the SMU controller 152 may transmit a command message to a first AMS, e.g., AMS 128-1 to control its N-switch 258 to connect the PV module 124-1 to string 140-1.

At block 712 (“P_IstrM<>0”), the SMU controller 152 may determine whether the negative string interconnect 148 registers a current. If so, then the SMU controller 152 may provide an indication of a ground fault of PV module 124-1 at block 716 (“Providing indication of GF at PV module (N)”). If P_IstrM does not register a current, the SMU controller 152 may provide an indication of no GF of AMS 128-1 at block 720 (“Providing indication of no GF at PV module (N)”). An indication of a GF (or no GF) may include, e.g., a status report/alert sent to user interface 424. In some embodiments, an indication of no GF may be implied through a non-indication of a GF.

At block 724 (“Disconnecting PV module (N)”), the SMU controller 152 may transmit a command message to the AMS 128-1 to control its N-switch 258 to disconnect PV module 124-1. This procedure of flow diagram 700 may be repeated for each of the managed modules 132.

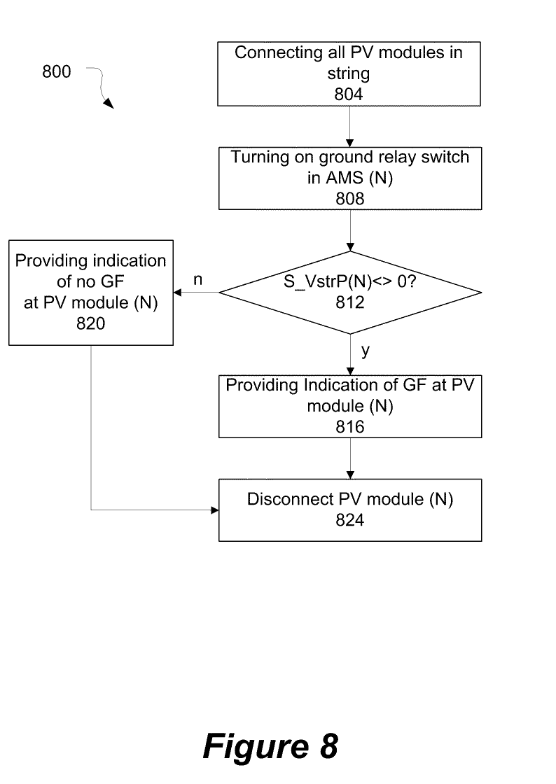

FIG. 8 is a flow diagram 800 of operations within a ground fault detection procedure in accordance with some embodiments of the disclosure. In particular, the flow diagram 800 may refer to detection of a high-resistance ground fault at the time of installation. In some embodiments, this may be done after the low-resistance GF test shown in flow diagram 700.

At block 804 (“Connecting all PV modules in string”), the SMU controller 152 may transmit a command message to all of the AMS of a given string, e.g., AMS 128-1-128-3 of string 140-1 to control their N-switches 258 to connect their corresponding PV modules 124 to the string 140-1.

At block 808 (“Turning on ground relay in AMS (N)”), the SMU controller 152 may transmit a command message to an AMS (N) to turn on its ground relay switch 260.

At block 812 (“S_VstrP(N)<>0”), the SMU controller 152 may determine whether a voltage across the frame ground and the M− terminal of PV module (N) registers a value, i.e., whether S_VstrP(N)<>0. This may be done by the SMU controller 152 receiving a status message from the first AMS (N). If so, then the SMU controller 152 may provide an indication of a ground fault with respect to PV module (N) at block 816 (“Providing indication of GF at PV module (N)”). If S_VstrP(N) does not register a value, the SMU controller 152 may provide an indication of no GF at PV module (N) at block 820 (“Providing indication of no GF at PV module (N)”). Similar to above, an indication of a GF (or no GF) may include, e.g., a status report/alert sent to user interface 424. In some embodiments, an indication of no GF may be implied through a non-indication of a GF.

At block 824 (“Disconnecting PV module (N)”), the SMU controller 152 may transmit a command message to the AMS (N) to control its N-switch 258 to disconnect PV module (N). This procedure of flow diagram 800 may be repeated for each of the remaining managed modules 132 of the string 140-1. A similar procedure may also be done for the remaining strings 140.

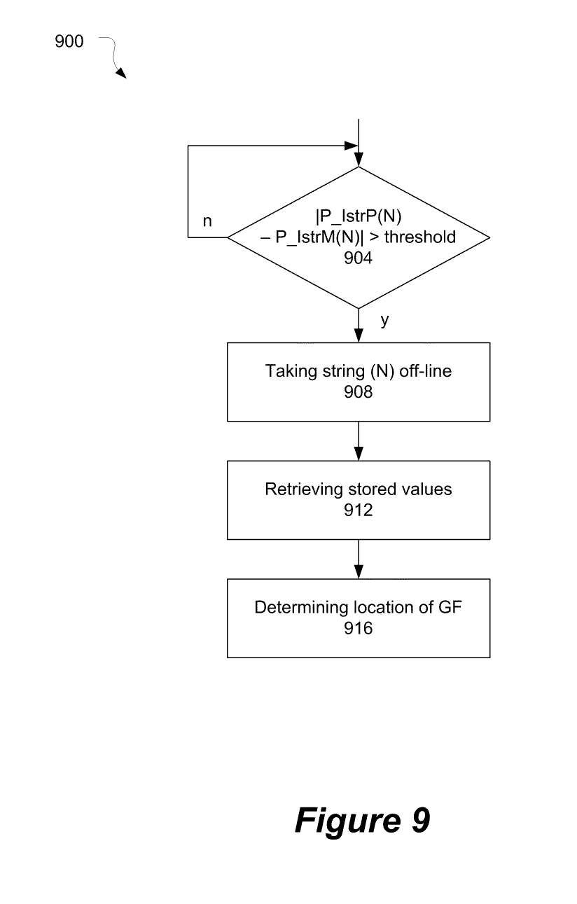

FIG. 9 is a flow diagram 900 of operations within a ground fault detection procedure in accordance with some embodiments of the disclosure. In particular, the flow diagram 900 may refer to detection of a ground fault during operation of the PV installation 100. This procedure may be used to quickly identify a ground fault and take a string 104 off-line thereby preventing a shutdown of the central inverter 108.

At block 904 (“|P_IstrP(N)-P_IstrM(N)|>threshold”), the SMU controller 152 may monitor currents on a string 140 to determine whether the full string current at the positive string interconnect 144 is different from the full string current at the negative string interconnect 148 by a delta value greater than a predetermined threshold value, i.e., whether |P_IstrP(N)-P_IstrM(N)|>threshold. The values of the string currents may be provided to the SMU controller 152 from the SMUs 136 where they are sensed. The predetermined threshold value may be set to a value that signifies a ground fault. If the delta value is greater than the predetermined threshold value, the SMU controller 152 may advance to block 908 to isolate and locate the GF.

At block 908 (“Taking string (N) off-line”), the SMU controller 152 may send a command message to all of the AMSs 128 on string 140 to control their N-switches 258 to disconnect the PV modules 124 from the string 140 and to turn on their ground relay switches 260. This may result, e.g., in the PV modules 124-1-124-3 being disconnected from the string 140-1.

At block 912 (“Retrieving stored values”), the SMU controller 152 may retrieve saved values of S_Ip(N). The SMU controller 152 may also retrieve, from the AMSs 128-1-128-3, values of S_VstrP(N), S_VstrM(N), and S_Vp(N) from a point just prior to the point at which the PV modules 124 were disconnected.

At block 916, (“Determining location of GF”), the SMU controller 152 may proceed to determine where the ground fault occurred in the string 140-1.

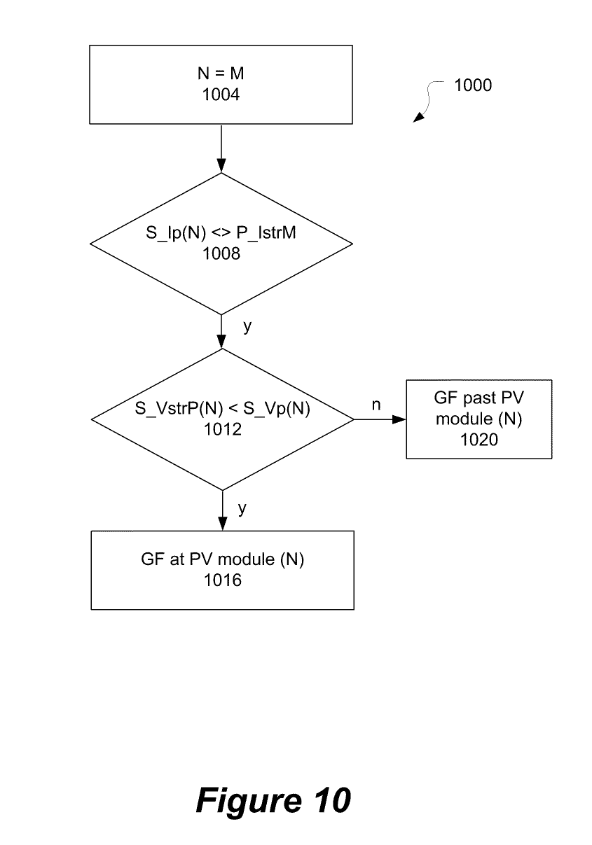

FIG. 10 is a flow diagram 1000 of operations within a determining location of ground fault of block 916 in accordance with some embodiments of the disclosure.

This determination may be initialized at block 1004 (“N=M”) by setting N equal to M, where M is the total number of PV modules 124 in the string 140.

At block 1008 (“S_Ip(N)<>P_IstrM”), it may be determined whether the current through PV module (N), which may be PV module 124-3 if N=M, is different from the full string current of the negative string interconnect 148. If these currents are different, the ground fault may be in the wire connecting the PV module (N) to the PV module (N+1) or in the PV module (N) itself. When N is equal to M, the “PV module (N+1)” may refer to the SC 104 rather than an actual PV module 124. If it is determined that these currents are different, in block 1008, the procedure may advance to block 1012 (“S_VstrP(N)<S_Vp(N)”). At block 1012, the SMU controller 152 may determine whether a voltage across the frame ground and the M− terminal of the PV module (N) is less than a voltage across the M+ and M− terminals of PV module (N), i.e., whether S_VstrP(N)<S_Vp(N). If so, the SMU controller 152 may then determine the ground fault is in the PV module (N) in block 1016 (“GF at PV module (N)”). Otherwise, the SMU controller 152 may determine that the ground fault is past PV module (N), e.g., in the wire connecting PV module (N) to PV module (N+1) or in PV module (N+1) itself, at block 1020 (“GF past PV module (N)”).

Another indication that may be used by the SMU controller 152 to determine the ground fault is in PV module (N) may be to determine whether the value of the voltage across the M+ terminal and the M− terminal of the PV module (N) is significantly less than the open circuit voltage of PV module (N), Voc(N), i.e., whether S_Vp(N)<<Voc(N). If this condition is determinable, it may indicate that that the ground fault is in the PV module (N). In some embodiments, the condition of S_Vp(N)<<Voc(N), when determinable, may supersede the condition of S_VstrP(N)<S_Vp(N).

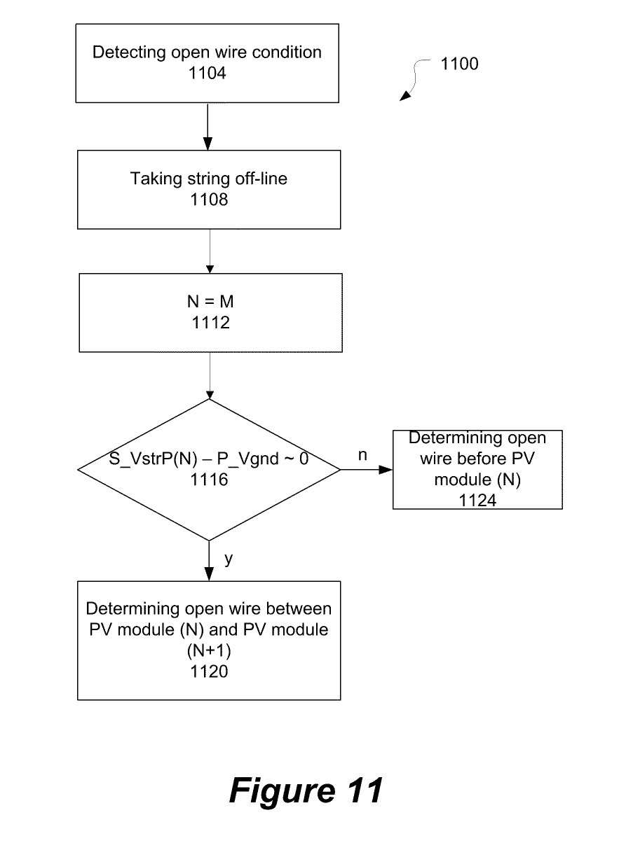

FIG. 11 is a flow diagram 1100 of operations within an open wiring detection procedure in accordance with some embodiments of the disclosure. In particular, the flow diagram 1100 may refer to detection and location of an open wire during operation of the PV installation 100.

At block 1104 (“Detecting open wire condition”), the SMU controller 152 may monitor the full string current at the negative string interconnect 148 and, when it goes to a value at or near zero, i.e., P_IstrM˜0, may determine that there is an open wire condition on string (N).

At block 1108 (“Taking string off-line”), the SMU controller 152 may send a command message to all of the AMSs 128 on, e.g., string 140-1, to control their N-switches 258 to disconnect the PV modules 124 from string 140-1 and to turn on their ground relay switches 260.

At block 1112 (“N=M”), N may be set to M.

At block 1116 (“S_VstrP(N)-P_Vgnd˜0”), the SMU controller 152 may determine whether the difference between voltage across frame ground and M− terminal of the PV module (N) and the voltage across system ground and negative string interconnect 148 is at or near zero, i.e., S_VstrP(N)-P_Vgnd˜0. If so, the SMU controller 152 may determine the open wire is between PV module (N) and PV module (N+1) at block 1120 (“Determining open wire between PV module (N) and PV module (N+1)”). Again, if N+1 is greater than M, than PV module (N+1) may refer to the SC 104. If the SMU controller 152 determines, at block 1116, the difference between voltage across frame ground and M− terminal and the voltage across system ground and negative string interconnect 148 is not at or near zero, the SMU controller 152 may determine that the open wire is before PV module (N) at block 1124 (“Determining open wire before PV module (N)”).

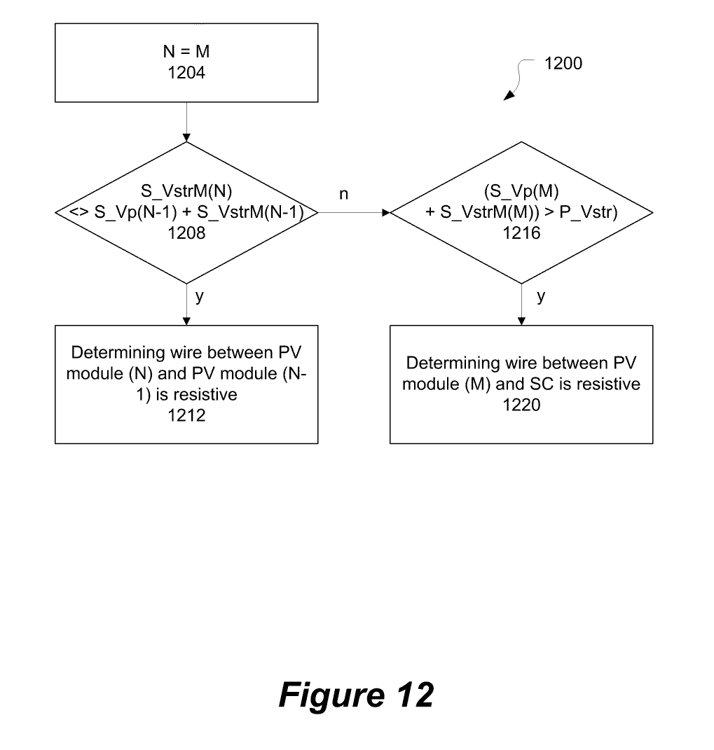

FIG. 12 is a flow diagram 1200 of operations within a weak wire detection procedure in accordance with some embodiments of the disclosure. In particular, the flow diagram 1200 may refer to detection of a weak wire in power and/or ground wires during operation of the PV installation 100.

At block 1204 (“N=M”), the SMU controller 152 may set N equal to M.

At block 1208 (“(S_VstrM(N)<>S_Vp(N−1)+S_VstrM(N−1)”), the SMU controller 152 may determine whether the voltage across the M− terminal of PV module (N) and the frame ground is different from the sum of voltage across the M+ and M− terminals of PV module (N−1) and voltage across the M− terminal of the PV module (N−1) and the frame ground, i.e., whether (S_VstrM(N)<>S_Vp(N−1)+S_VstrM(N−1). If so, the SMU controller 152 may determine that the wire between PV module (N) and PV module (N−1) is resistive at block 1212 (“Determining wire between PV module (N) and PV module (N−1) is resistive”). If not, and if N is equal to M as initialized in block 1204, then the SMU controller 152 may determine whether the sum of the voltage across the M+ and M− terminals of the PV module (M) and voltage across M− terminal of PV module (M) and the frame ground are greater than the full string voltage, i.e., whether (S_Vp(M)+S_VstrM(M))>P_Vstr, at block 1216 (“(S_Vp(M)+S_VstrM(M)>P_Vstr)”). If so, the SMU controller 152 may determine that the wire between the PV module (M) and the SC 104 is resistive at block 1220 (“Determining wire between PV module (M) and the SC 104 is resistive”).

For the bottom PV module, e.g., PV module (0), the SMU controller 152 may determine whether a difference between the voltage across the frame ground and the M− terminal of the PV module (0) and the voltage across the system ground and the negative string interconnect 148 is greater than a voltage drop threshold value, i.e., whether (S_VstrP(0)-P_Vgnd)>Voltage_drop_Threshold. If so, the SMU controller 152 may determine that the wire between PV module (0) and the SC 104 is resistive. The voltage drop threshold value may be a predetermined value that identifies a resistive condition.

In various embodiments the SMU controller 152 may determine an existence and location, whether precise or approximate, of a variety of conditions that may occur at installation and/or operation of the PV installation 100. An example, in addition to the ones discussed above, may include a determination that a fuse has blown, e.g., by determining that both a full string voltage, i.e., P_Vstr, and a full string current at the positive string interconnect, i.e., P_IstrP, are not equal to zero. Another example, may include determining the existence of a faulty blocking diode by measuring a voltage drop across the diode under test. If the voltage is zero, the diode may be determined to be shorted. If the voltage is greater than the normal voltage drop, the diode may be determined to be open. Yet another example may include determining an existence of a faulty bypass diode. This may be determined by determining that the M+ voltage of PV module (N) is significantly less than a maximum power voltage of PV module (N) (Vmp(N)), i.e., S_Vp(N)<<Vmp(N). If so, the SMU controller 152 may determine that the bypass diode of PV module (N) could be open. If it is determined that the M+ voltage of PV module (N) is significantly less than the open circuit voltage of PV module (N), i.e., S_Vp(N)<<Voc(N) when the module (N) is bypassed by turning on its N-switch 258, then the SMU controller 152 may determine that the bypass diode may be shorted.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the disclosure. Those with skill in the art will readily appreciate that embodiments of the disclosure may be implemented in a very wide variety of ways. This disclosure is intended to cover any adaptations or variations of the embodiments discussed herein. Therefore, it is manifestly intended that embodiments of the disclosure be limited only by the claims and the equivalents thereof.

What is claimed is:

1. A method comprising:
sensing a first full string current at a positive string interconnect of a string electrically coupled with a plurality of photovoltaic (PV) modules;
sensing a second full string current at a negative string interconnect of the string;
determining that a difference between a first value, associated with the first full string current, and a second value, associated with second full string current, is greater than a predetermined threshold value; and
providing a command to each active module sensor of a plurality of active module sensors that are electrically coupled with the plurality of PV modules to disconnect the plurality of PV modules from the string based on said determining.

2. The method of claim 1, further comprising:
communicating with one or more of the plurality of active module sensors to determine a location of a ground fault.

3. The method of claim 2, wherein said determining the location includes:
retrieving, from a last active module sensor that is associated with a last PV module electrically coupled with the string, a third value, which is associated with a current through the last PV module;
determining that the third value is different from the second value; and
determining that the ground fault is in either the last PV module or a string combiner electrically coupled with the string based on said determining that the third value is different from the second value.

4. The method of claim 3, further comprising:
determining that a first voltage, across a positive terminal and a negative terminal of the last PV module, is less than a second voltage, across the frame ground and the negative terminal of the last PV module; and
determining that the ground fault is in the last PV module based on said determining that the first voltage is less than the second voltage.

5. A method comprising:
associating a plurality of active module sensors (AMSs) with a radio hub of a string management unit controller, wherein each of the plurality of AMSs is electrically coupled with a corresponding photovoltaic (PV) module; and
associating a first set of the plurality of AMSs with a first string by transmitting, to the plurality of AMSs, a series of command messages to selectively connect or disconnect corresponding PV modules to or from the first string.

6. The method of claim 5, wherein said associating the plurality of AMSs with the radio hub comprises:
transmitting a broadcast association message, including a hub identifier, via a wireless transmission.

7. The method of claim 5, wherein said associating the first set of the plurality of AMSs with the first string comprises:
transmitting a first command message to all of the plurality of AMSs to disconnect corresponding PV modules from respective strings;
transmitting a second command message to a first AMS of the plurality of AMSs to connect a first PV module, corresponding to the first AMS, to the first string;
transmitting a third command message to a second AMS of the plurality of AMSs to connect a second PV module, corresponding to the second AMS, to an undetermined string;
sensing a non-zero voltage change at a string combiner; and
determining that the undetermined string is the first string based on said sensing of the non-zero voltage change.

8. The method of claim 5, further comprising:
determining an interconnection order of the first set of AMSs based on grading values of voltages across negative terminals of the PV modules that correspond to the set of AMSs and respective frame grounds.

9. The method of claim 5, further comprising:
associating each string of two or more strings with a respective string management unit in a string combiner.

10. The method of claim 9, wherein said associating each string with a respective string management unit (SMU) comprises:
selecting a first AMS of the plurality of AMSs to connect a first PV module, corresponding to the first AMS, to the first string;
turning on a string identificatioN-switch in a string combiner;
identifying a first SMU of a plurality of SMUs as recording a current; and
associating the first SMU with the first string.

11. A system comprising:
a plurality of photovoltaic (PV) modules electrically coupled to one or more strings with each string having at least two PV modules serially coupled with one another;
a string combiner coupled with the one or more strings; and
a plurality of active module sensors, each active module sensor of the plurality of module sensors electrically coupled with a corresponding PV module of the plurality of PV modules and communicatively coupled with the string combiner and configured to communicate with the string combiner to manage the plurality of PV modules.

12. The system of claim 11, further comprising:
an array link gateway communicatively coupled with the string combiner and configured to communicatively couple the string combiner to a network.

13. The system of claim 11, wherein the string combiner is electrically coupled with the plurality of active module sensors and the PV modules; and is further communicatively coupled, via a wireless connection, with the plurality of active module sensors to communicate control information with the plurality of active module sensors.

14. The system of claim 11, wherein a first active module sensor of the plurality of active module sensors comprises:
a voltage monitor configured to continuously monitor voltage associated with a first PV panel electrically coupled with the first active module sensor.

15. The system of claim 11, wherein a first active module sensor of the plurality of active module sensors comprises:
a switch configured to alternately connect and disconnect a first PV panel, electrically coupled with the first active module sensor, from a first string of the one or more strings.

16. The system of claim 15, wherein the switch is configured to disconnect the first PV panel from the first string in an event of a ground fault detected by the string combiner.

17. A method comprising:
turning on a ground fault test switch in a string combiner;
sending a first command message to a first active module sensor, electrically coupled with a first photovoltaic (PV) module, to connect the first PV module to a first string;
determining that a negative string interconnect, electrically coupled with the string combiner, registers a current; and
providing an indication of a ground fault with respect to the first PV module based on said determining.

18. The method of claim 17, further comprising:
controlling a plurality of AMSs, respectively corresponding to a plurality of PV modules, to test each of the plurality of PV modules for a low-resistance ground fault.

19. A method comprising:
sending one or more command messages to a set of active module sensors (AMSs), electrically coupled with a set of photovoltaic (PV) modules of a first string, to connect the set of PV modules to the first string;
sending a first command message to a first AMS of the set of AMSs to turn on a ground relay switch;
determining that a voltage across a frame ground and a negative terminal of the first PV module is not equal to zero; and
providing an indication of a ground fault with respect to the first PV module based on said determining.

20. The method of claim 19, wherein said determining comprises:
receiving, by a string management unit controller, a message from the first AMS.

21. The method of claim 19, further comprising:
controlling a plurality of AMSs, respectively corresponding to a plurality of PV modules, to test each of the plurality of PV modules for a high-resistance ground fault.

22. An apparatus comprising:
a plurality of electrical interconnects configured to electrically couple the apparatus with a photovoltaic (PV) module and a string interconnect;
a current sensor configured to measure a current associated with the PV module;
a switch;
a transceiver configured to transmit current measurements to, and receive command messages from, a string combiner; and
a controller coupled with the transceiver and configured to control the switch to disconnect the PV module from the string interconnect.

23. The apparatus of claim 22 wherein the transceiver is a wireless transceiver.

24. The apparatus of claim 22, further comprising:
a voltage monitor configured to monitor a voltage; and
the transceiver is further configured to transmit voltage measurements to the string combiner.

25. The apparatus of claim 22, further comprising:
the PV module including a first section and a second section; and
a voltage regulator having a first bypass diode coupled in parallel with the first section, a second bypass diode coupled in parallel with the second section, wherein the voltage regulator is electrically coupled to a node between the first section and the second section.
